(19) United States
(12) Patent Application Publication
(10) Pub. No.: US 2005/0066290 A1
(43) Pub. Date: Mar. 24, 2005

(54) Pop-up capture

(76) Inventors: Anil Kumar Chebolu, Atlanta, GA (US); Timothy A. Hill, Kennesaw, GA (US); Marie Louise McMenamin, Marietta, GA (US); Zakir S. Patrawala, Atlanta, GA (US); Samira S. Virani, Atlanta, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 10/741,632

(22) Filed: Dec. 19, 2003

Related U.S. Application Data
(60) Provisional application No. 60/503,364, filed on Sep. 16, 2003.

(51) Int. Cl. G06F 3/00

(52) U.S. Cl. 715/808; 715/747

(57) ABSTRACT

The present disclosure provides systems and methods for controlling the displaying of a pop-up window on a computer. Briefly described in architecture, some embodiments of such a system provide a pop-up monitor to detect a request to display a pop-up window, and a pop-up inhibitor to prevent the displaying of a pop-up window if a current user of the computer has not requested the pop-up window to be displayed. Other systems and methods are also provided.

### CROSS-REFERENCE TO RELATED APPLICATIONS

This application claims priority to U.S. provisional application having Ser. No. 60/503,364, filed Sep. 16, 2003, which is entirely incorporated herein by reference.

This application is related to copending U.S. utility patent applications entitled “Controlling User-Access to Computer Applications” filed on the same day as the present application and accorded Ser. No. ______, which is entirely incorporated herein by reference; “Synchronizing Automatic Updating of Client,” filed on the same date as the present application and accorded Ser. No. ______, which is entirely incorporated herein by reference; “Time-Based Computer Access Controls,” filed on the same date as the present application and accorded Ser. No. ______, which is entirely incorporated herein by reference; “Online User-Access Reports with Authorization Features,” filed on the same date as the present application and accorded Ser. No. ______, which is entirely incorporated herein by reference; “Remote Administration of Computer Access Settings,” filed on the same date as the present application and accorded Ser. No. ______, which is entirely incorporated herein by reference; and “Client Comparison of Network Content with Server-Based Categorization,” filed on the same date as the present application and accorded Ser. No. ______, which is entirely incorporated herein by reference.

### TECHNICAL FIELD

The present disclosure relates generally to personal computers and, more particularly, to systems and methods for controlling computer access.

### BACKGROUND

With the advent of the Internet, unsolicited advertisements have become prevalent during Internet browsing. For example, pop-up advertisements are a type of graphical window display that appears on top, as one example, of an Internet browser display of a Web page that a user is viewing. Currently, software applications exist, which attempt to limit pop-up advertisements that interfere with a user's Internet browsing. Such applications, however, are not adequate to effectively control unsolicited pop-up window displays.

Thus, a heretofore unaddressed need exists in the industry to address the aforementioned deficiencies and inadequacies.

### SUMMARY

The present disclosure provides systems and methods for controlling the displaying of a pop-up window on a computer. Briefly described in architecture, some embodiments of such a system provide a a pop-up monitor to detect a request to display a pop-up window, and a pop-up inhibitor to prevent the displaying of a pop-up window if a current user of the computer has not requested the pop-up window to be displayed. Some embodiments, among others, of a method for controlling computer access to Internet content comprise the steps of: intercepting a request to display a pop-up window; detecting if a current user of the computer requested the displaying of the pop-up window; and displaying the pop-up window if the current user is detected to have requested the pop-up window.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of one embodiment of a system for controlling the displaying pop-up windows of the present disclosure.

FIGS. 2A-2B are diagrams showing pop-up window displays that are controlled by the system of FIG. 1.

FIG. 3 is a flowchart describing one embodiment of a process for controlling the displaying pop-up windows in the system of FIG. 1.

FIG. 4 is a flowchart describing one embodiment of a process for classifying a user activity in the system of FIG. 1.

FIG. 5 is a flowchart describing one embodiment of a process for controlling the displaying of pop-up windows in the system of FIG. 1.

### DETAILED DESCRIPTION OF THE PREFERRED EMBODIMENTS

Reference is now made in detail to the description of the embodiments as illustrated in the drawings. While several embodiments are described in connection with these drawings, there is no intent to limit to the embodiment or embodiments disclosed herein. On the contrary, the intent is to cover all alternatives, modifications, and equivalents.

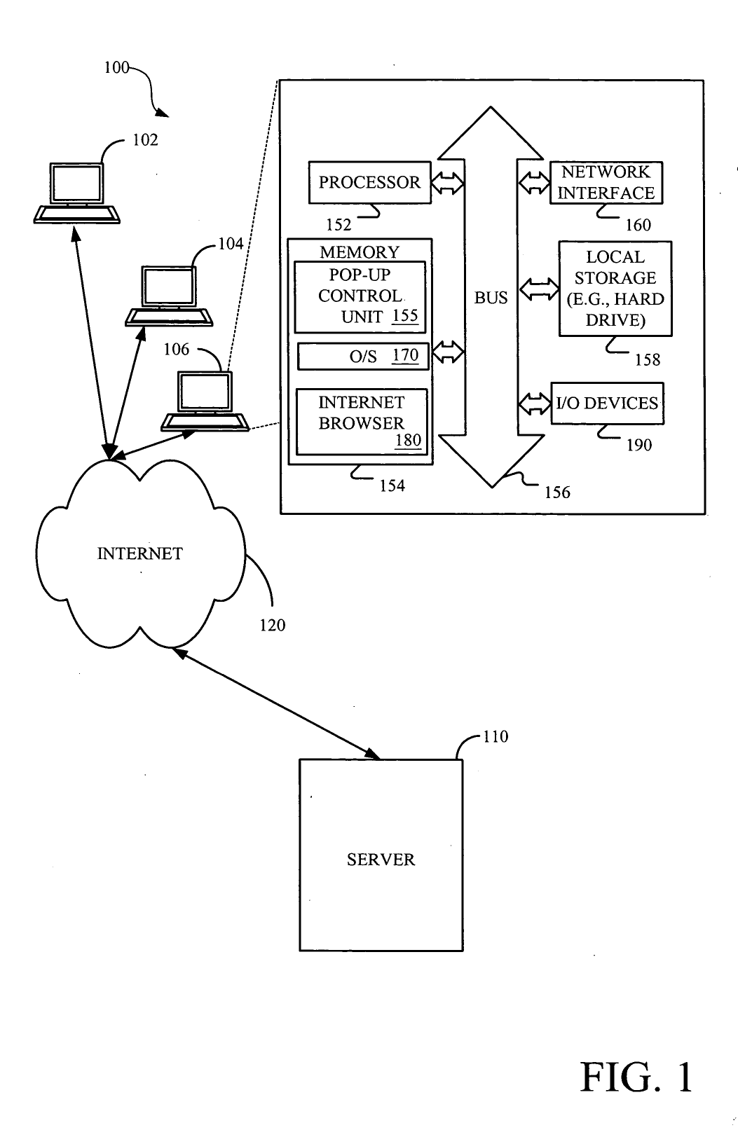

The present disclosure provides systems and methods for preventing unsolicited pop-up window displays from being shown on a general-purpose computer. FIG. 1 is a block diagram of one embodiment of the system 100 for controlling the displaying of pop-up windows. As shown in FIG. 1, the pop-up control system 100 comprises general-purpose computers 102, 104, 106 that are coupled to a server 110 over a network such as the Internet 120. Typically, the communication network 120 provides access to Internet services such as email, File Transfer Protocol (FTP), World Wide Web (WWW), Internet Relay Chat (IRC), etc. and newsgroups, such as Usenet, via servers 110 on the network 120.

In the operating environment shown in FIG. 1, a user of a general-purpose computer 106 attempts to access applications on the computer 106 and services over the network 120. As shown in FIG. 1, the general-purpose computer 106 includes a processor 152, a network interface 160, memory 154, a local storage device 158, and a bus 156 that permits communication between the various components. While not explicitly shown, it should be appreciated that the other computers 102, 104 may also include similar components that facilitate computation or execution of applications on the computers 102, 104. In some embodiments, the local storage device 158 may be a hard drive configured to electronically store data. The local storage device 158 may also store computer programs that execute on the computer 106. In this sense, the processor 152 is configured to access any program that is stored on the local storage device 158 and execute the program with the assistance of memory 154.

The network interface 160 is configured to provide an interface between the general-purpose computer 106 and the network 120. Thus, the network interface 160 provides the interface for the computer 106 to receive any data that may be entering from the network 120 and, also, to transmit any data from the computer 106 to the network 120. Specifically, in some embodiments, the network interface 160 is configured to permit communication between each of the computers 102, 104, 106 and the server 110 and, additionally, to permit communication between the computers 102, 104, 106 themselves. In this regard, the network interface 160 may be a modem, a network card, or any other interface that communicatively couples each of the computers 102, 104, 106 to the network. Since various network interfaces are known in the art, further discussion of these components is omitted here.

Typically, a user may download the pop-up control unit 155 as a separate software module in various embodiments. However, in some embodiments, the pop-up control unit may be integrated into other software applications such as an Internet browser 180 or other computer display/access control mechanisms, such as parental control software. In other embodiments, the pop-up control unit 155, is provided via computer disks, computer cards, or other file-storage devices, or is pre-installed on the general-purpose computer 106. In the embodiment of FIG. 1, a pop-up control unit 155 is shown as being loaded into memory 154 for launching at the general-purpose computer 106, thereby permitting the pop-up control unit 155 to prevent unsolicited pop-up window displays from being launched on the general-purpose computer 106. Typically, the processes of the pop-up control unit 155 are executed upon start-up of an Internet browser 180 (although the pop-up control 155 unit may also be activated or de-activated upon a manual command from a user).

I. Architecture

The pop-up control unit 155 of the present embodiment can be implemented in software, firmware, hardware, or a combination thereof. Preferably, the pop-up control unit 155 is implemented in software, as an executable program, and is executed by a special or general-purpose digital computer 106, such as a personal computer, workstation, minicomputer, or mainframe computer.

Memory 154 can include any one or combination of volatile memory elements (e.g., random access memory (RAM, such as DRAM, SRAM, etc.)) and nonvolatile memory elements (e.g., ROM, hard drive, tape, CDROM, etc.). Moreover, memory 154 may incorporate electronic, magnetic, optical, and/or other types of storage media. Note that memory 154 can have a distributed architecture, where various components are situated remote from one another, but can be accessed by the processor 152.

The software in memory 154 may include one or more separate programs, each of which comprises an ordered listing of executable instructions for implementing logical functions. In the example of FIG. 1, the software in memory 154 includes the pop-up control unit 155 and an operating system (O/S) 170. The operating system 156 essentially controls the execution of other computer programs, and provides scheduling, input-output control, file and data management, memory management, and communication control and related services.

The pop-up control unit 155 may be a source program, executable program (object code), script, or any other entity comprising a set of instructions to be performed. If the pop-up control unit 155 is a source program, then the program needs to be translated via a compiler, assembler, interpreter, or the like, which may or may not be included within memory 154, so as to operate properly in connection with the O/S 170. Furthermore, the pop-up control unit 155 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices 190 may include input devices, for example but not limited to, a keyboard, mouse, scanner, digital camera, multi-function device, digital sender, microphone, etc. Furthermore, the I/O devices 190 may also include output devices, for example but not limited to, a printer, display, etc. Finally, the I/O devices 190 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

The software in memory 154 may further include a basic input output system (BIOS) (omitted for simplicity). The BIOS is a set of essential software routines that initialize and test hardware at startup, start the O/S 170, and support the transfer of data among the hardware devices. The BIOS is stored in ROM so that the BIOS can be executed when the computer 106 is activated.

When the computer 106 is in operation, the processor 152 is configured to execute software stored within memory 154, to communicate data to and from the memory 154, and to generally control operations of the computer 106 pursuant to the software. The pop-up control unit 155, Internet browser application 180, and the O/S 170, in whole or in part, but typically the latter, are read by the processor 152, perhaps buffered within the processor 152, and then executed.

When the pop-up control unit 155 is implemented in software, as is shown in FIG. 1, it should be noted that the pop-up control unit 155 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The pop-up control unit 155 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the pop-up control unit 155 is implemented in hardware, the pop-up control unit 155 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

II. Operation

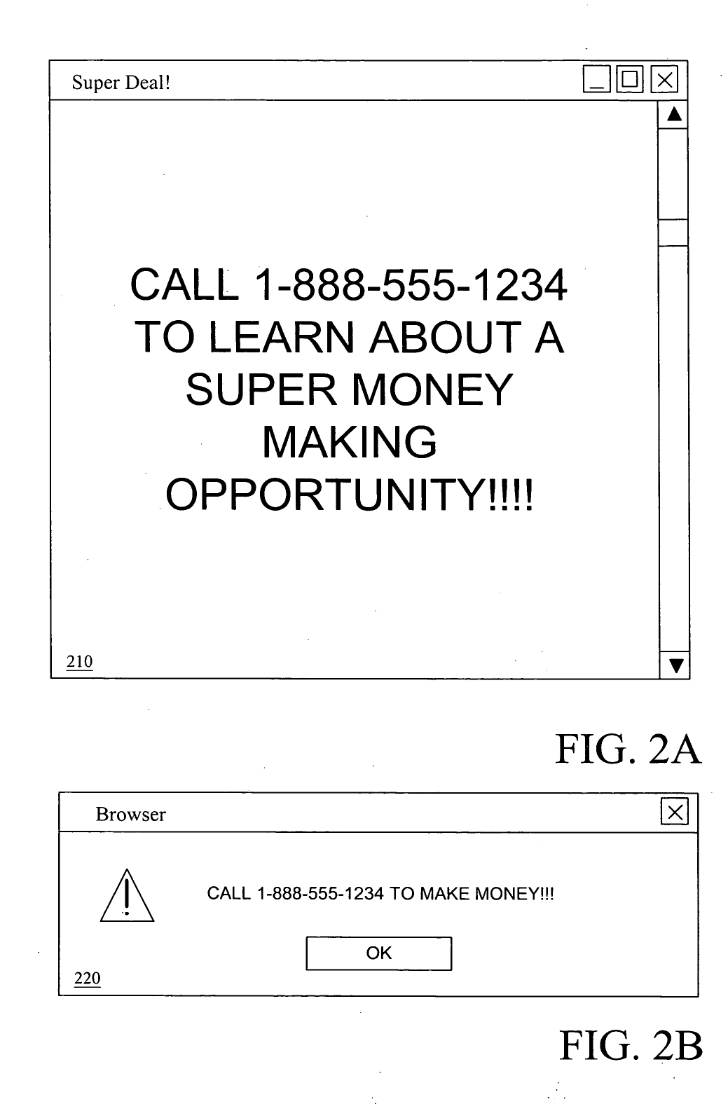

FIGS. 2A-2B show two examples of pop-up windows, among others, that are often displayed on computers and are controlled by embodiments of the present disclosure. FIG. 2A depicts a pop-up window display 210 of an Internet browser window, and FIG. 2B depicts a pop-up window display 220 of a Javascript® alert message. Other types and forms of pop-up window displays are also controlled by embodiments of the present disclosure, as discussed hereinafter.

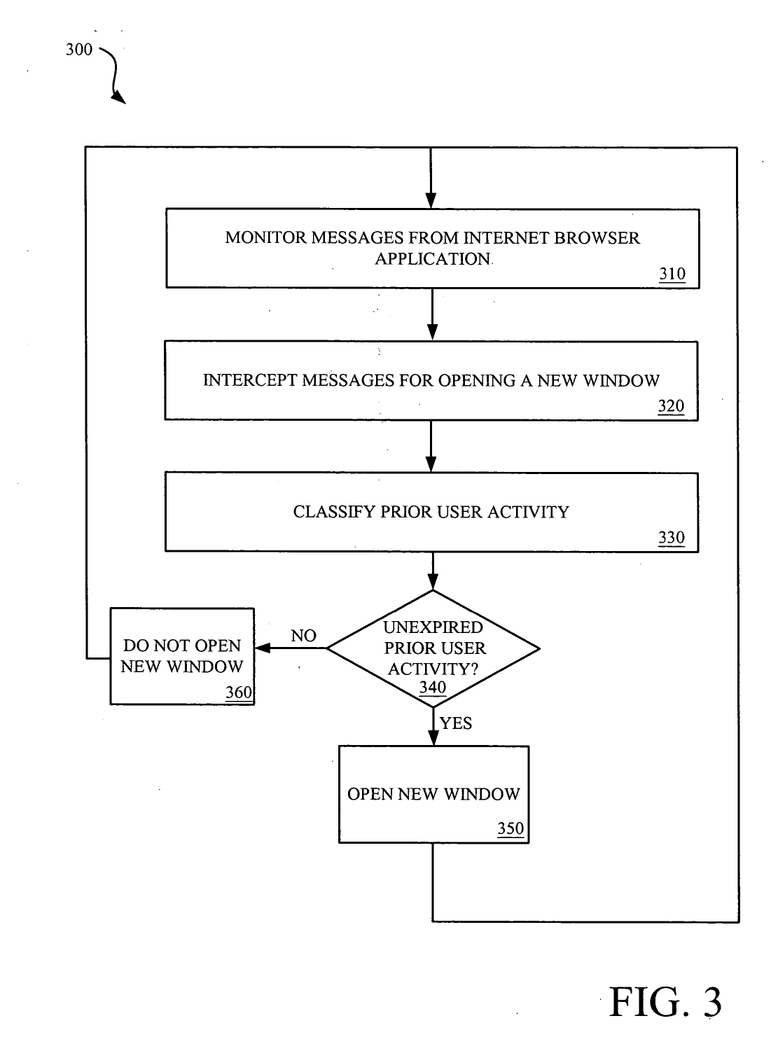

The flowchart of FIGS. 3-5 shows the functionality of a representative implementation of the system 100 for controlling the displaying of pop-up windows. It should also be noted that in some alternative implementations, the functions noted in the various blocks may occur out of the order depicted in the flowcharts of FIGS. 3-5. For example, two blocks shown in succession in FIGS. 3-5 may, in fact, be executed substantially concurrently. Alternatively, the blocks may sometimes be executed in the reverse order depending upon the functionality involved.

Typically, pop-up window displays are categorized by whether a pop-up window display is initiated from a user-generated event (e.g., a “click” of a computer mouse, a keyboard stroke, etc.) or a non-user generated event where the user did not request that a new window be launched. Accordingly, a user typically does not desire pop-up window displays that are generated from a non-user-generated event. Therefore, the system 100 for controlling the displaying of pop-up windows attempts to suppress such window displays from being launched.

The system 100 also attempts to suppress undesired pop-up window displays that are initiated by a user-generated event. For example, by clicking on a hypertext link, a user may unwittingly cause extraneous pop-up windows that are not desired by the user to be launched and displayed on the general-purpose computer 106. Further, by attempting to close one of these pop-up window displays, the user may cause additional undesired pop-up windows to be launched causing the process (of launching extraneous pop-up windows) to frustratingly repeat itself. Accordingly, it is also the aim of the system 100 for controlling the displaying of pop-up windows to prevent undesired pop-up windows from being launched from a user-generated event, in accordance with some embodiments of the present disclosure.

As depicted in FIG. 3, the functionality of a representative embodiment of the system 100 or method 300 for controlling launching of pop-up windows displays may be construed as beginning at block 310. First, the pop-control unit 155 monitors messages from the Internet browser application 180 directed to a windows-based operating system 170 and intercepts (320) messages for opening a new window.

Note, a windows-based operating system is essentially a message driven operating system in the sense that, the majority of actions that take place are responses to messages sent to the main window procedure of an application. Therefore, one approach, among others, for intercepting messages in this type of windows environment, among others, involves hook mechanisms (e.g., “Windows® shell hook” program) that can monitor and intercept messages before the Windows® O/S 170 has decided to which application to direct the message. For example, a Windows® shell hook program monitors a running application and is notified by the O/S 170 when the application opens a graphical user interface (GUI) window. Accordingly, the pop-up control unit 155 may intercept any messages from a mouse or keyboard application that attempts to open or close a window. In some embodiments, the windows-based operating system 170 is a Microsoft Windows® operating system (98, ME, XP, 2000, NT, etc.).

Most Internet browsers are also windows-based and provide mechanisms (e.g., hook functions) for monitoring whether the Internet browser is attempting to launch a new window for a web page, close a window, refresh a page in window, etc. in a similar manner as a windows-based O/S 170. For example, an Internet Explorer® helper object (“IE Helper COM Object”) can install hook components to monitor and control messages and actions of the Internet Explorer® browser. The hook component is notified when a user requests a document identified by a uniform resource identifier (URI). Further, the hook component can also monitor other events that a user performs (such as keyboard and computer mouse activity). Note, other mechanisms may be used to intercept commands to launch applications within a windows-based O/S 170, other operating systems, and other computer applications and are contemplated by the present disclosure.

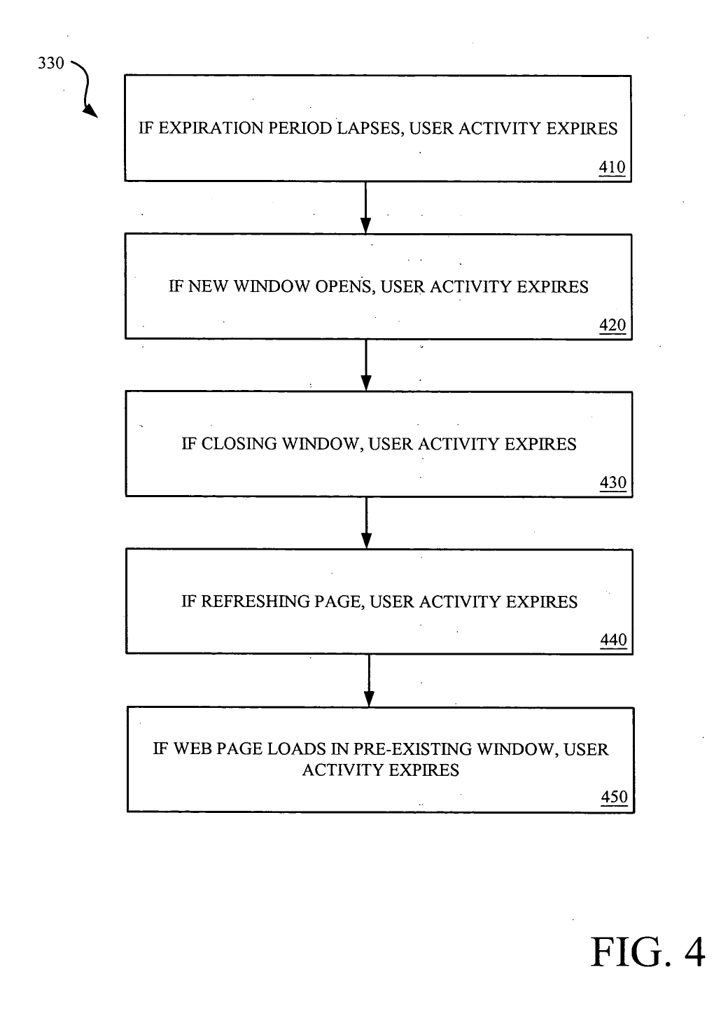

Depending on the state of prior user activity (e.g., unexpired previous activity or expired previous activity), the pop-up control unit 155 processes the message (for opening a new window display) and forwards it to the windows-based operating system 170 or discards the message so that a new window display is not launched. To make this determination, the prior user activity is classified (330) by the pop-up control unit 144 as being expired or unexpired. There are several events that can cause a prior user activity to expire (i.e., be deemed expired), as shown in FIG. 4. First, all user activity expires (410) after a set period of time (“expiration period”), such as 0.5 seconds. Accordingly, any mouse click or a keyboard stroke expires after 0.5 seconds.

In addition, all user activity expires after a new window display is opened (420); all user activity also expires after a message for closing a window (e.g., wm_close message) is detected (430); all user activity expires after a message is detected to refresh the contents of a window (440); and all user activity expires after a new web page is loaded within a pre-existing window (450) (that was displaying a web page). The significance of each of the events that causes the expiration of user activity is described below.

Referring back to FIG. 3, after the pop-up control unit 155 intercepts the message to open a new window display, the pop-up control unit determines (340) if there is any user activity that occurred before the message was intercepted and has not expired. If there is prior user activity that has not expired, then the message to open a new window is process (350) and forwarded to the O/S 170 to allow one singular new window display to open. Then, as previously described, all previous user activity is set (420) to a state of being expired. However, if all prior user activity has expired, then the message to open a new window is discarded by the pop-up control unit 155 and is not processed. Thus, a new window display is not opened (360), and the process then repeats itself.

Next, consider the following examples, among others, of undesired pop-up window displays and how each are handled by the pop-up control unit 155. First, consider a pop-up window display that is automatically launched on a user's Internet browser 180 without prompting by the user. For this type of pop-up window display, the pop-up control unit 155 intercepts the message to open the pop-up window in step 320, and since no user activity caused the pop-up window to be launched, all prior user activity has expired (after 0.5 seconds). Thus, the message to open the pop-up window display is discarded (360)

Now, consider extraneous pop-up window displays that are opened when a user clicks on a link which automatically opens a new window. First, the pop-up control unit 155 intercepts the message to open the new window in step 320, and since the user activity (e.g., a mouse click on a link) caused a new window to attempt to open, the message to open the new window is processed (350) and a new window is opened. In addition, upon opening the new window, all user activity is expired (420). In this way, if messages to open additional extraneous windows are subsequently generated and intercepted, the pop-up control unit will discard these messages (360) since all prior user activity has expired. Therefore, for applications where a user desires to click on a hyperlink to launch a new window (e.g., clicking on a media stream that will automatically cause a window to open for a media player that plays the media stream), one new singular window display is opened as desired by the user.

Also, consider if the user closes one pop-up window display (e.g., by a mouse click, a keystroke, etc.) and the action of closing the pop-up window causes a message for opening a new pop-window display to be generated. Although a period of time between the user activity that closed the window and the generation of the message to open the new window may be less than the expiration period, the prior user activity caused a message for closing a window to be generated. Thus, the pop-up control unit detects (310) the message for closing a window and as a result, the pop-up control unit sets the state of the prior user activity to being expired (430). Therefore, the message to open a new window is not processed (360), since the prior user activity has expired.

Another type of problem solved by the pop-up control unit 155 involves automatic page refreshes. Consider, a user who has a particular web page displayed on one window of an Internet browser application 180. The particular page, however, may have program code or script that causes the Internet browser application 180 to request the particular web page to refresh itself. Accordingly, upon refresh, new pop-up windows may attempt to be launched. However, the pop-up control unit 155 can detect if the Internet browser 180 has generated any messages to refresh the contents of a window. Upon detection of message for refreshing a window, the pop-up control unit 155 sets the state of prior user activity to being expired (440). Therefore, if the user happens to initiate a keystroke or mouse click right before the new window is attempted to be launched (due to a page refresh), the message to open the new window is discarded (360) since the prior user activity was set as being expired.

Next, consider pop-up window displays that are launched when a user clicks on a hypertext link (within a first web page) to open a new web page within the same window that was displaying the first web page. To prevent this type of pop-up window displays, the pop-up control unit 155 intercepts the message to open a new window for displaying the pop-up window display in step 320 that was caused by “clicking” on the link in the first web page. As described in FIGS. 3-4, since the user activity (e.g., a mouse click on a link) causes a new web page to open within a pre-existing window, the user activity expires (340 & 440), and the new window is not opened (350).

In some embodiments, a user can authorize pop-up windows from being blocked or prohibited by the pop-up control unit 155 for certain Internet domains. Particularly, the primary user may specify particular Internet domain addresses that are allowed to launch pop-up windows without interference by the pop-up control unit 155. In these embodiments, after the pop-up control unit 155 detects (310-320) that an Internet browser is attempting to launch a new window, the pop-up control unit 155 checks to see if the current domain address of the source web page that is being accessed by the user is on the user's whitelist (list of authorized source web pages) that is stored on the general-purpose computer 106. If the domain address of the source web page is on the user's whitelist, then the pop-control unit 155 allows any new window to be launched while the source web page is currently being viewed by the user. If the domain address of the source web page is not on the user's whitelist, the pop-control unit operates as shown in FIG. 3 and determines if a message to open a new window should be discarded (360).

In a similar manner for some embodiments, a user may manually override the operation of the pop-up control unit 155 by pressing predefined key combinations on a keyboard, for example. Therefore, in these embodiments, the pop-up control unit 155 may determine if a particular key combination is not being pressed before performing the process in FIG. 3.

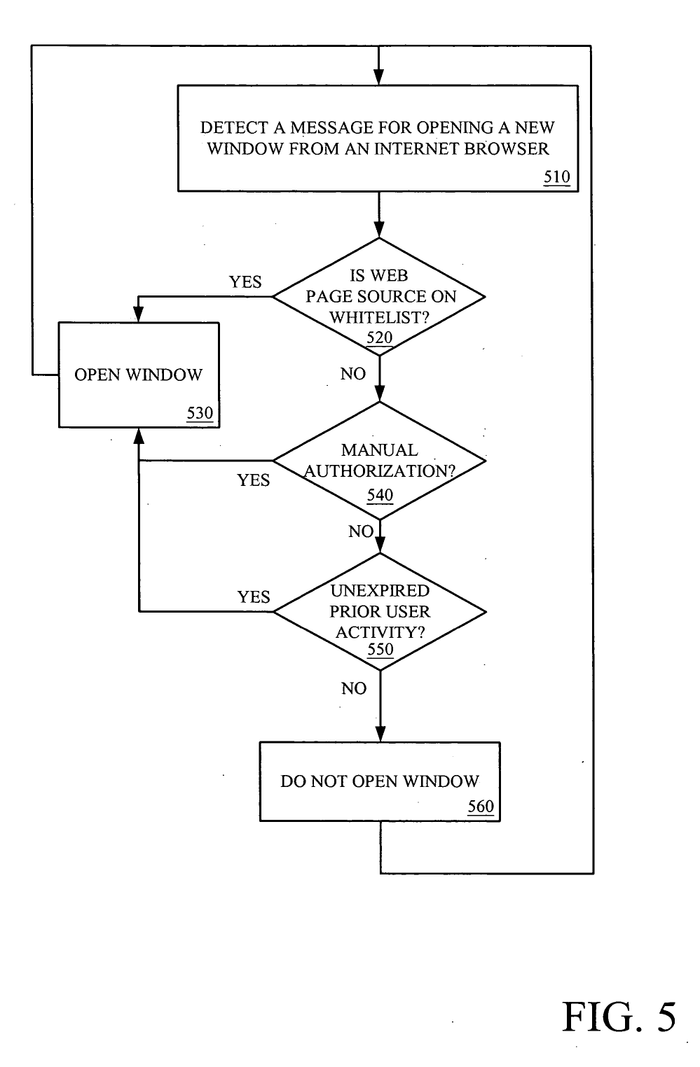

Accordingly, FIG. 5 is a flowchart that describes one embodiment of the functionality of the pop-up control unit 155. First, the pop-up control unit 155 detects (510) a message (from an Internet browser application) for opening a new window display. To determine whether a new window display should be opened, the pop-up control unit determines (520) if the source of the web page (e.g., Internet domain name) currently active on the Internet browser is contained in a whitelist of the user. If the current web page is on the whitelist of the user, the pop-up control unit 155 processes the message for opening a new window display and allows the new window to open (530). If the current web page is not on the whitelist, the pop-up control unit 155 determines (540) if the user is manually authorizing the opening of the new window display by pressing a particular (predefined) key combination. If the user has manually authorized the opening of the new window display, then, the new window is allowed to open (530). However, if the user has not manually authorized the opening of the new window and if the prior user activity has not expired (550), the pop-up control unit 155 allows the new window to open (330), as previously explained. If the prior user activity has expired, then the pop-up control unit 155 does not allow the window to open (560), and the process then repeats itself.

Advantageously, operation of the pop-up control unit 155 is based on user activity and not on the types of media that a user is attempting to access over the Internet that initiates a request to open a pop-up window display. In this way, the pop-up control unit 155 can effectively capture pop-up windows that are launched from any type of Internet media. It should be emphasized that the above-described embodiments are merely possible examples of implementations, merely set forth for a clear understanding of the principles of the disclosure. For example, the pop-up control unit 155 may be configured to alert the user that a pop-up window has been blocked by playing a distinct sound or chime. Many variations and modifications may be made to the above-described embodiments without departing substantially from the spirit and principles of the invention. All such modifications and variations are intended to be included herein within the scope of this disclosure.

1. A system for controlling a pop-up window from being displayed on a computer, the system comprising:
a pop-up monitor to detect a request to display a pop-up window; and
a pop-up inhibitor to prevent the displaying of a pop-up window if a current user of the computer has not requested the pop-up window to be displayed.

2. The system of claim 1, the pop control monitor comprising logic configured to intercept a request to display the pop-up window; and the pop-up inhibitor comprising logic configured to:
detect if the current user of the computer requested the displaying of the pop-up window; and
process the request to display the pop-up window if the current user is deemed to have requested the pop-up window.

3. The system of claim 1, the pop-up inhibitor logic further configured to:
prohibit an additional pop-up window from being displayed unless the current user is detected to have requested the additional pop-up window.

4. The system of claim 1, wherein the request is a message to open a new window.

5. The system of claim 1, wherein the pop-up inhibitor does not analyze which web page links that the user has activated.

6. The system of claim 1, wherein the pop-up inhibitor analyzes prior user commands and avoids analyzing content within a web page that the user has directly activated.

7. A method to control a pop-up window from being displayed on a computer, the method comprising the steps of:
intercepting a request to display the pop-up window;
detecting if a current user of the computer requested the displaying of the pop-up window; and
displaying the pop-up window if the current user is detected to have requested the pop-up window.

8. The method of claim 7, further comprising the step of:
prohibiting an additional pop-up window from being displayed unless the current user is detected to have requested the additional pop-up window.

9. The method of claim 7, wherein the request is a message to open a new window.

10. The method of claim 7, wherein the detecting step does not analyze which web page links that the user has activated.

11. The method of claim 7, wherein the detecting step analyzes prior user commands and avoids analyzing content within a web page that the user has directly activated.

12. A computer-readable medium for storing a program that a pop-up window from being displayed on a computer, the method comprising the steps of:
intercepting a request to display the pop-up window;
detecting if a current user of the computer requested the displaying of the pop-up window; and
displaying the pop-up window if the current user is detected to have requested the pop-up window.

13. The medium of claim 12, the program further comprising the step of:
prohibiting an additional pop-up window from being displayed unless the current user is detected to have requested the additional pop-up window.

14. The medium of claim 12, wherein the request is a message to open a new window.

15. The medium of claim 12, wherein the detecting step does not analyze which web page links that the user has activated.

16. The medium of claim 12, wherein the detecting step analyzes prior user commands and not content within a web page that the user has directly activated.
